(19) United States
(12) Patent Application Publication
(10) Pub. No.: US 2018/0343329 A1
(43) Pub. Date: Nov. 29, 2018

(54) Home & Sleep Button Blocker for Smart Devices

(71) Applicant: Jaclyn Robinson, Heritage Circle Mobile, AL (US)

(72) Inventor: Jaclyn Robinson, Heritage Circle Mobile, AL (US)

(21) Appl. No.: 15/605,654

(22) Filed: May 25, 2017

(51) Int. Cl. H04M 1/02; H04W 12/04

(52) U.S. Cl. CPC H04M 1/026; A45C 2011/002; H04W 12/04

(57) ABSTRACT

This invention is a device that is placed on an encased or non-encased smart device (tablet, phone) that covers and blocks the home button and sleep buttons on the smart device in order to prevent the buttons from being accessed, pressed, or utilized. After the blocking device is placed on a smart device, only the app/activity that was open/running immediately prior to the blocking device being placed onto the smart device can be used.

### BACKGROUND

### Background of the Invention

Smart devices provide a button (referred to as the “home” button) for exiting active apps in order to return to the home screen. Pressing the home button brings all other applications and tools of the smart device into view and they are accessible to the user. Smart devices provide a button (referred to as the “sleep” button) for putting the device into sleep mode. This action puts the device “to sleep” and upon reactivation by pressing the home or sleep button, the user is now fully or partially blocked from the application that was active prior to the sleep button being pressed.

The functions of the sleep and home button are necessary for full usage of smart devices; however, the functions of these two buttons are problematic when a smart device is in the hands of a young child. Access to these two buttons introduces various issues by allowing a small child entry to applications and device utilities that are not intended for them.

### Field of the Invention

A blocking device that fits on smart devices (tablets, smart phones) and blocks the home & sleep buttons, preventing the current/active app from being exited and prevents the smart device from being put into sleep mode.

### Description of the Related Art

3D art created; 3D file of plastic injection mold created; Final prototype of blocking piece created; Drawings/Illustrations/Photographs of blocking device created

### SUMMARY

This invention is a blocking device that is placed on encased or non-encased smart devices (phones, tablets) to cover the home & sleep buttons in order to prevent these buttons from being accessed, pressed, or utilized.

This invention prevents a user from exiting the app currently open/running on a smart device.

This invention prevents a user from opening any new apps on a smart device.

This invention prevents a user from utilizing the smart device in any way other than the activity that was open/running when the invention was placed onto the smart device.

This invention placed on a smart device prevents the user from opening apps, placing calls, or performing any activity on the device other than the app/activity that was selected/opened/running prior to placing the invention onto the smart device.

This invention creates the ability for guardians of young children to block the home and sleep buttons on a smart device to prevent the child from putting the smart device to sleep and from exiting the open app the guardian selected/opened prior to placing the invention onto the smart device.

Plastic 3D printing and plastic injection molding are two method options for manufacturing this blocking object using the 3D file I have created.

### BRIEF DESCRIPTION OF THE DRAWINGS

The blocking device comes in a variety of sizes, each to specifically fit multiple smart devices, encased and non-encased in various brands of cases.

The “Sample Blocking Device Measurements” drawing documents the exact measurements of a sample-blocking device for an encased iPhone 6s.

Pictures provided illustrate the look and fit of a sample prototype-blocking device on an encased iPhone 6.

### DETAILED DESCRIPTION

This invention is one solid device (10) that fits snuggly onto an encased or non-encased smart device.

The top of the device (12) wraps over the top portion of the encased or non-encased smart device and assists in holding the piece firmly in place.

The bottom of the device (14) wraps over the bottom portion of the encased or non-encased smart device, covering the home button on the smart device to prevent it from being pressed.

The bottom of the device (14) wraps over the bottom portion of the encased or non-encased smart device and assist in holding the piece firmly in place.

The bottom of the device (16) has two openings to provide access to charging and headphone portals.

The small side strip (18) wraps around the side of the encased or non-encased smart device, covering the sleep button.

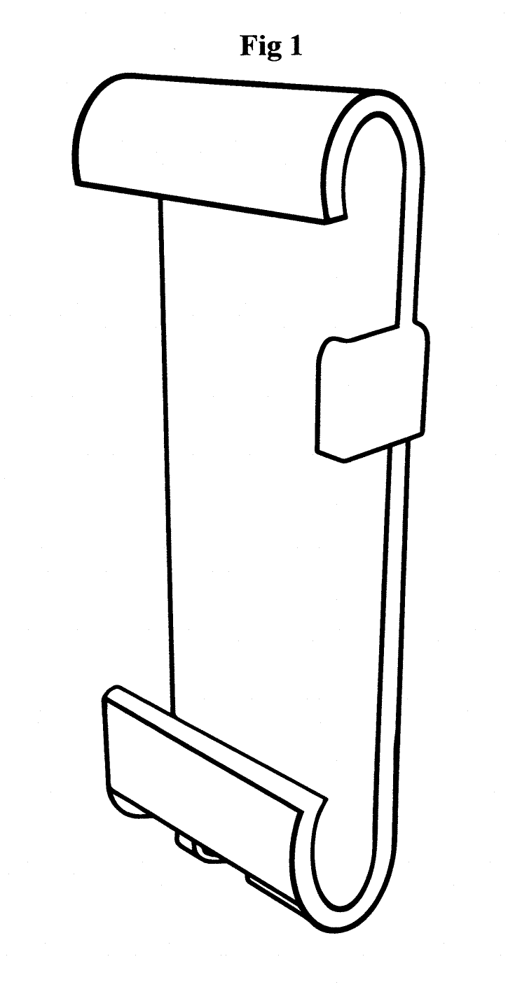

FIG. 1: an image of the front of the “home and sleep button blocker” sample prototype

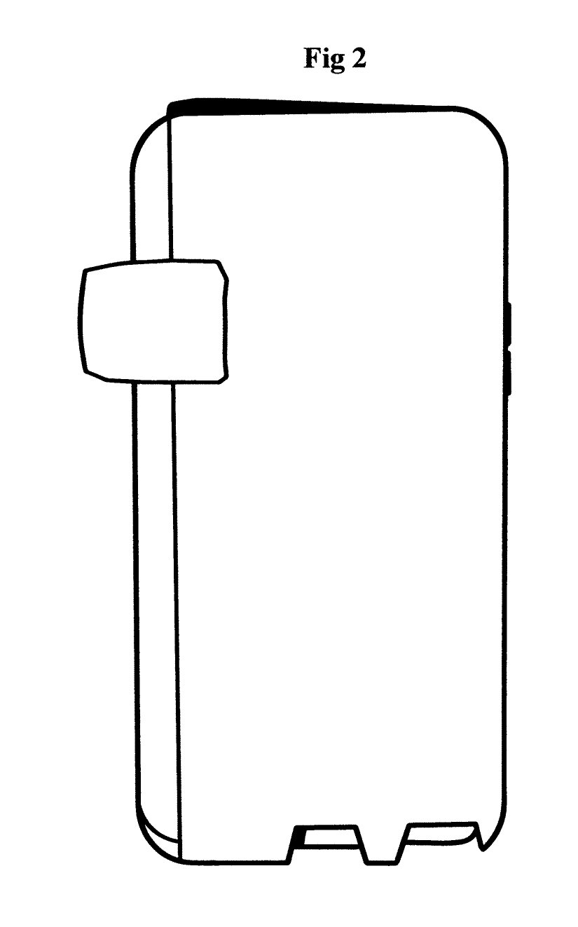

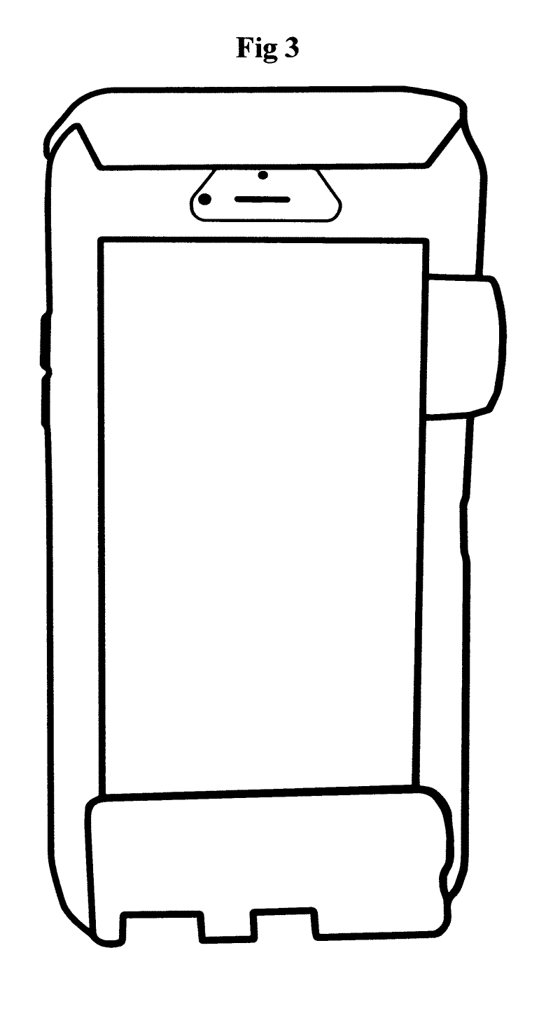

FIG. 2: an image of the sample prototype on an encased iPhone 6

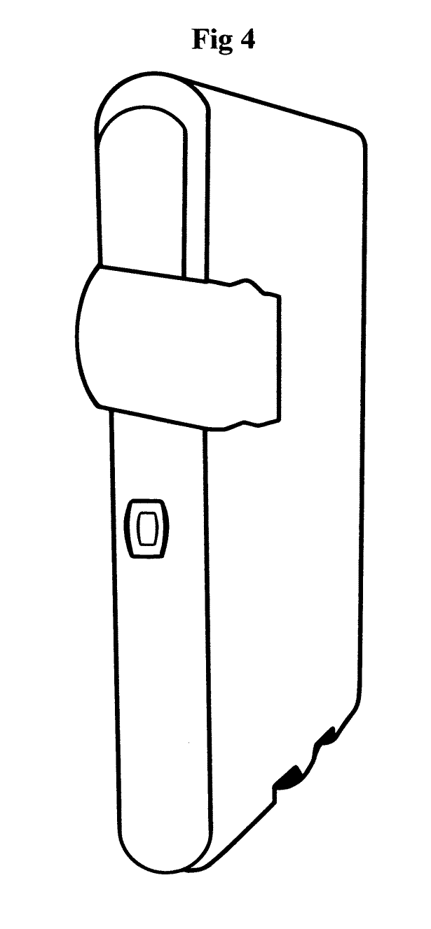

FIG. 3: an image of the left side of the sample prototype

FIG. 4: an image of the back of the sample prototype

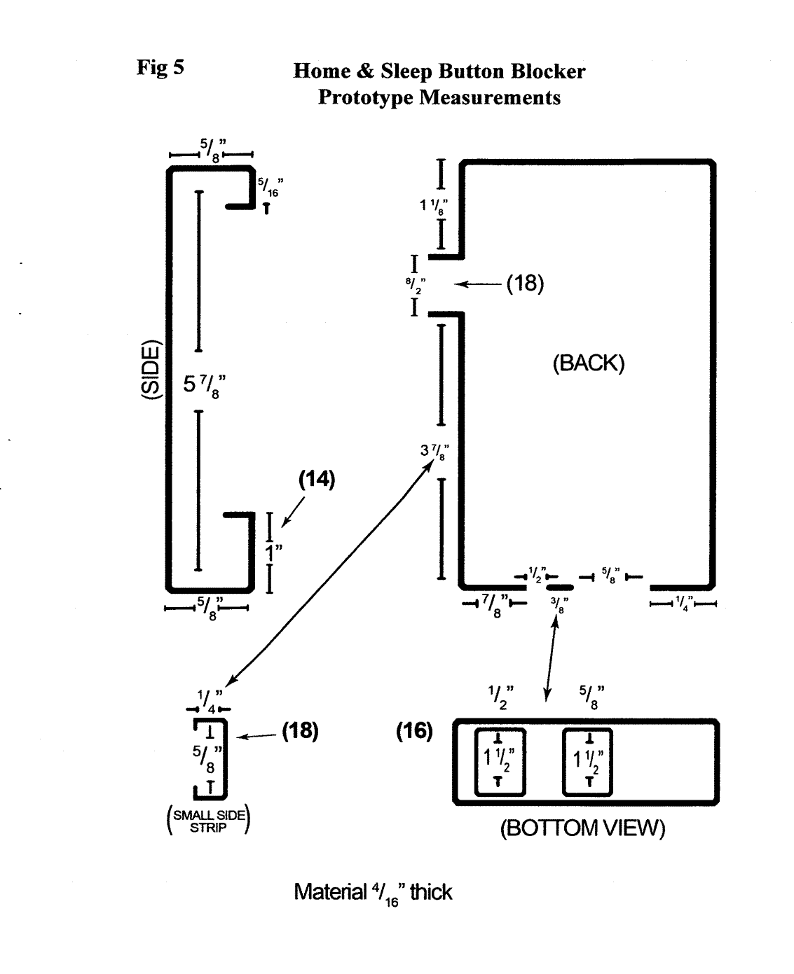

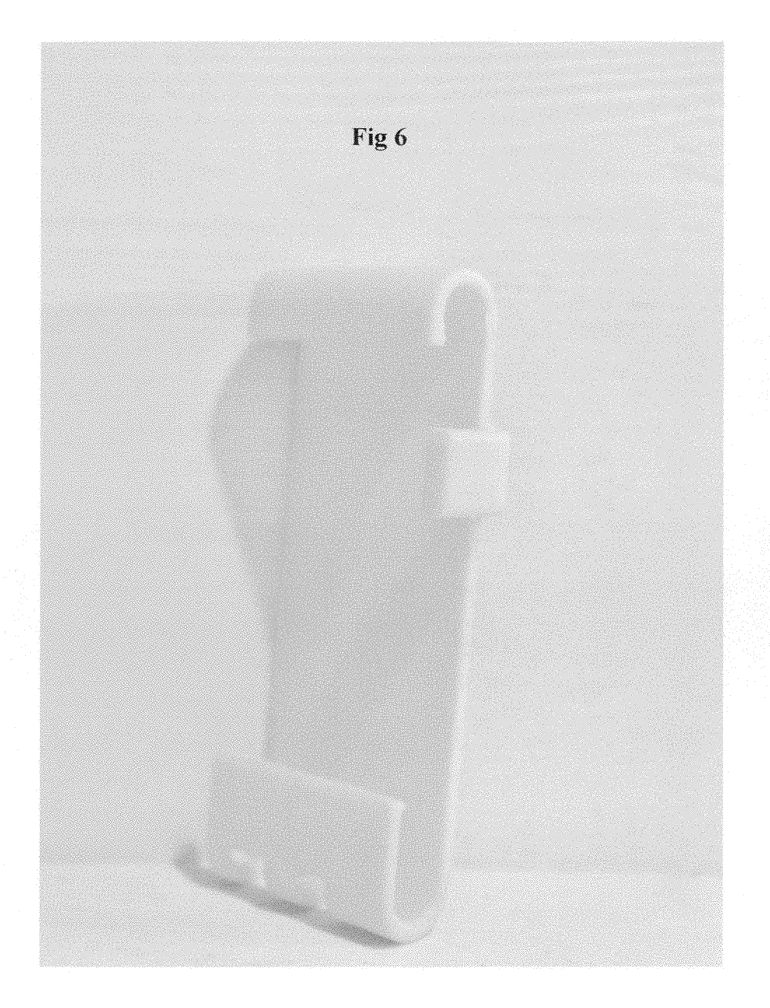

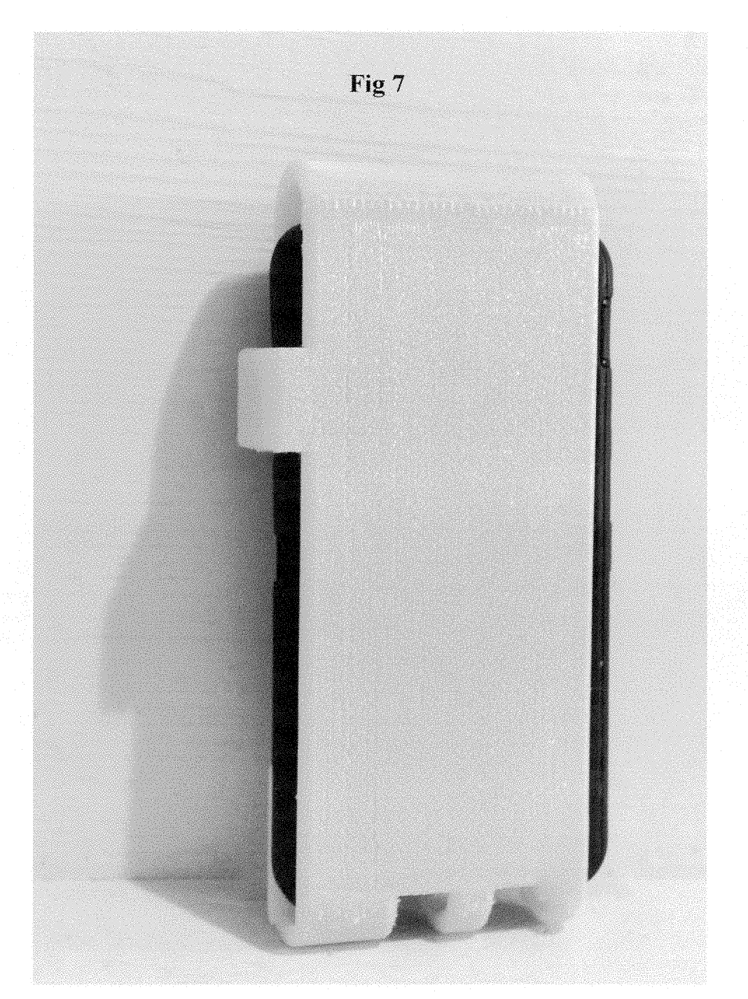

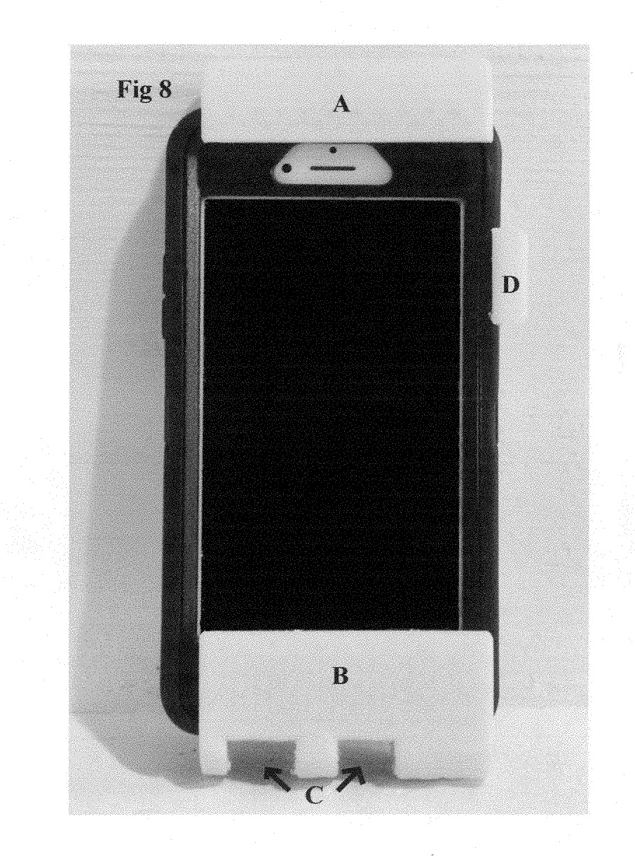

FIG. 5: an image of the right side of the sample prototype

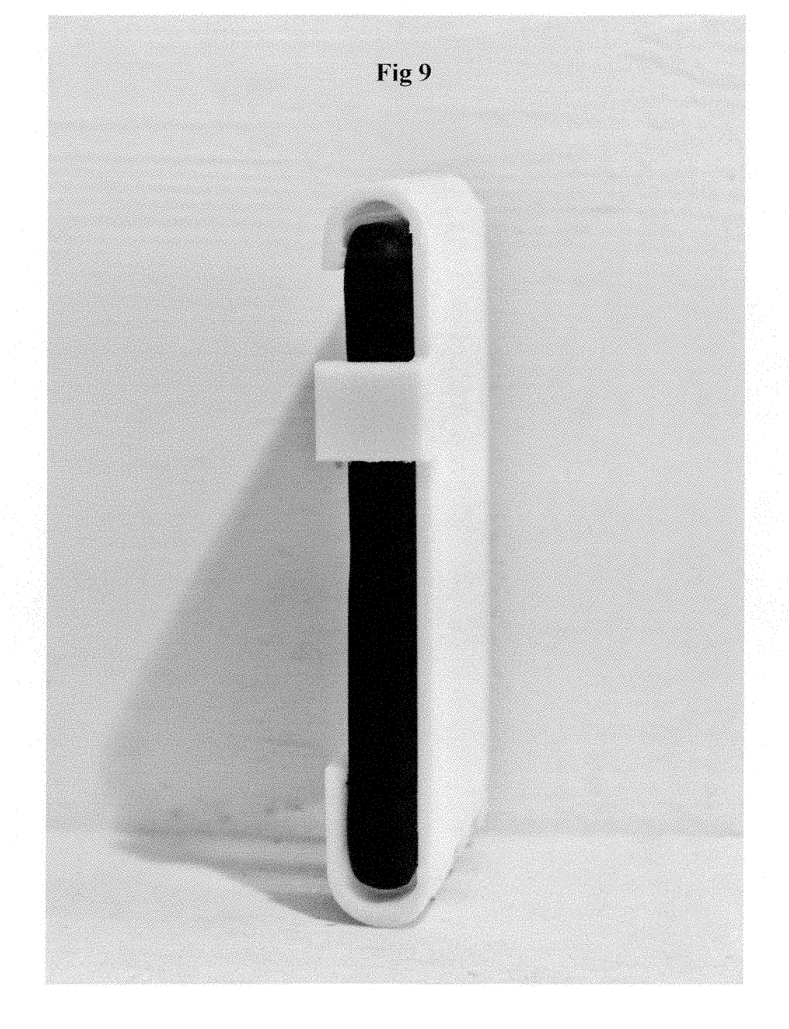

FIG. 6: an image of the bottom of the sample prototype

1. A device for blocking the home and sleep buttons on a smart device, comprising:
protrusion configured to block said sleep button; wrap over edges to block said home button; a precisely measured fit of said blocking device holding it in place on a smart device.

2. A device according to claim 1 that blocks the home and sleep buttons on an encased or non-encased smart device preventing the home and sleep buttons from being accessed, pressed, or utilized.
